(19) United States
(12) Patent Application Publication
(10) Pub. No.: US 2021/0140183 A1
(43) Pub. Date: May 13, 2021

(54) CONFIGURABLE FORM SYSTEM FOR FABRICATING PRECAST PANELS

(71) Applicant: MW Panel Tech, LLC, Fort Worth, TX (US)

(72) Inventor: Jonathan White, Hurst, TX (US)

(73) Assignee: MW Panel Tech, LLC, Fort Worth, TX (US)

(21) Appl. No.: 17/150,262

(22) Filed: Jan. 15, 2021

Related U.S. Application Data
(63) Continuation-in-part of application No. 16/123,744, filed on Sep. 6, 2018, now Pat. No. 10,947,746.

(51) Int. Cl. E04G 17/04; E04G 11/08

(52) U.S. Cl. CPC E04G 17/042; E04G 11/08

(57) ABSTRACT

A configurable form system for creating precast concrete panels is disclosed. The configurable form system can be used to create precast panels for both commercial tilt panels and highway noise barrier walls, among other applications. A plurality of form system sections are preferably fabricated from steel plate bent into a J-channel member. The configurable form system can be designed in sections that are quickly assembled. To suit a particular application, a section can be extended by sequentially attaching extension members to a primary member. A plurality or faces or shoring apparatuses can be coupled to the section to circumscribe or form an inner diameter of an enclosure formed by the sections. The shoring apparatuses can vary in height, allowing for fabrication of panels of variable thickness using the same forms or framework. The shoring apparatuses can be configured to removably engage ends of sections to facilitate the formation of enclosures using the sections.

### CROSS REFERENCE TO RELATED APPLICATIONS

This application is a Continuation-in-Part of U.S. application Ser. No. 16/123,744, filed Sep. 6, 2018, the entirety of which is incorporated herein by reference. This application hereby cross-references U.S. application Ser. No. 17/110,540 filed Dec. 11, 2020, and PCT Application Serial No. PCT/US19/49017 filed Nov. 21, 2019, the entireties of which are incorporated herein by reference.

### BACKGROUND

### Field of the Invention

The present invention is generally related to steel form systems, and more specifically to systems and methods for creating configurable precast concrete panels.

### Background of the Invention and Description of Related Art

Concrete panels have long been used in commercial construction projects. Due to the difficulty and expense associated with transporting the concrete panels from a fabrication facility to a worksite, the concrete panels are generally fabricated at the worksite. Conventional approaches generally suffer from the same drawbacks: they are wasteful, require unnecessary man-hours to erect, and require continued replacement cost.

Typical industry processes create frameworks made of lumber near a worksite, so concrete panels can be poured and cured. Wooden components are typically employed due to their low cost. However the wood can warp and produce uneven surface in a resulting concrete panel. The combination of concrete and wood results in problems. As the water bleeds out of the concrete, the wood absorbs the water exacerbating the warping and minimizing the number of uses. As wood is not rigid, the wooden framework also requires bracing, typically every twelve inches, to support the framework, resulting in additional expense. The wooden edges of the framework are also prone to chip. The complexity and manpower required to construct this wooden framework (cutting individual components, bracing the pieces, and fastening the components together) coupled with the extra equipment required to form such components, results in wasted man-hours and greater expense, to create a flawed product. Add in the tear down, removal resupplying of such a wooden framework and the waste is further multiplied. Further, a typical assembly time for such a wooden framework is approximately forty-five minutes.

Other approaches include the use of aluminum frameworks, but such frameworks are expensive and subject to work site theft due to their expense. Additional equipment is also required as the individual aluminum members must be cut and then assembled. Reuse is similarly difficult, with the added burden of dismantling the aluminum framework to remove the concrete panel, removing the bolts, and cleaning the components with a wire brush to remove the concrete residue. Additionally, varying panel thickness using these traditional frameworks is very difficult; generally, a new framework of a different height will need to be fabricated in order to change the panel thickness, requiring significant time and effort to construct and install.

### SUMMARY

The present invention achieves technical advantages as a configurable form system for creating precast concrete panels. The modular form system can be used to create precast panels for both commercial tilt panels and highway noise barrier walls, among other applications. A plurality of steel form system sections are preferably fabricated from ⅛″ or 3/16″ steel plate bent into a J-channel member. The configurable steel form system can be designed in 10′ sections that are quickly assembled with connectors to extend the length of a section. To suit a particular application, a section can be extended by sequentially attaching extension members to a primary member. In one embodiment the connector is a quick-release mechanism disposed on a connector plate for ease and speed of connection. Each section has the panel depth and contour fabricated into the steel form profile. The anchoring slots and corner miters are also cut into the form's framework. In another embodiment a plurality of members are configured to form precast concrete panels. In another embodiment, a shoring apparatus (face) or a plurality thereof can be coupled to sections to facilitate the fabrication of panels. Preferably, the faces can be fabricated from a material lighter than steel, such that the overall weight of the system can be reduced. The apparatuses can be of variable height to allow formation of panels of variable thickness using the same sections. In some embodiments, the shoring apparatus can be coupled to any type of framework known in the art, such as wooden or aluminum frameworks.

One exemplary embodiment of the disclosure can include a configurable form system. The system can comprise a plurality of sections, and each section can include a shoring surface. The system can further include a plurality of faces, and each face can be configured to couple to at least one of the shoring surfaces. Further, each of the shoring surfaces can be configured to couple to one of the faces. Each of the faces can also comprise a first chamfer disposed along a first edge of the face. In one embodiment, each face can be configured to removably engage an end of a section.

Another exemplary embodiment of the present disclosure can include a method of forming panels, such as concrete panels. The method can include providing a plurality of form members; coupling a plurality of faces to the plurality of form members; connecting the plurality of form members to one another to form at least three sections; removably engaging the three sections with one another to form an enclosure; and depositing a material within the enclosure. The plurality of faces can form an inner circumference of the enclosure. In one embodiment, each of the faces can include a top and bottom chamfer.

Another exemplary embodiment of the present disclosure can include a shoring apparatus. The shoring apparatus can comprise a back portion configured to abut a first section. The apparatus can also include a front portion configured to contact a material, such as, for example, concrete. The apparatus can further include a top portion comprising a first chamfer, and a bottom portion comprising a second chamfer. The apparatus can also include a coupling mechanism configured to removably couple the apparatus to the first section. Preferably, the coupling mechanism can include a hole in the apparatus through which a threaded fastener can extend, such as to be secured with a nut.

The systems, methods, and apparatuses disclosed herein provide several advantages in the art. For example, in accordance with the principles of the present disclosure, the same framework can be used to form panels of variable thickness simply by changing out the faces. As another example, utilizing a material lighter than steel (e.g., high-density polyethylene) for the chamfers (and/or faces the chamfers are a part of) renders the system less cumbersome while maintaining the ability to create, e.g., beveled edges and removably engage an end of a section with a chamfered-side of another section. Further, use of removably-coupled shoring apparatuses can provide advantages to frameworks known in the art, such as by preventing heavy absorption of moisture by, for example, wood frameworks, that can lead to warping. The shoring apparatuses described herein can also reduce the cost of fabricating frameworks, sections, and form members known in the art and discussed herein, because any sort of design desired to be imparted to the sides of a given panel (e.g., beveled edges enabled by chamfers) can be incorporated into the shoring apparatuses as opposed to the framework itself. This is extremely advantageous, as dedicated forms for different types of panels (e.g. top chamfer only, bottom chamfer only, no chamfer, etc.) can be avoided, as such customization can be accomplished via the shoring apparatus. Because the shoring apparatus can be easily fabricated such as be extrusion, these customizations are easily incorporated. Other advantages will be apparent to those of ordinary skill in the art.

### BRIEF DESCRIPTION OF THE DRAWINGS

FIG. 1 is a perspective view of a configurable steel form system, in accordance with an embodiment of the present disclosure;

FIG. 2A is a perspective view of a first end of a Form B member, in accordance with an embodiment of the present disclosure;

FIG. 2B is a perspective view of a second end of a Form A member, in accordance with an embodiment of the present disclosure;

FIG. 2C is a perspective view of a first end of a Form B member aligned with a second end of a Form A member, for formation of a section, in accordance with an embodiment of the present invention;

FIG. 3A is a perspective view of a first end of a Form B member aligned with a second end of a Form A member, for formation of a section, in accordance with another embodiment of the present disclosure;

FIG. 3B is a perspective view of a second end of a Form A member aligned with a first end of a Form B member, for formation of a section, in accordance with another embodiment of the present disclosure;

FIG. 3C is a perspective view a first end of a Form B member coupled with a second end of a Form A member, to form a section, in accordance with another embodiment of the present disclosure;

FIG. 4 is a perspective view of a mitered first end of a Form A member, in accordance with an embodiment of the present disclosure;

FIG. 5 is a perspective view of a corner of the configurable steel form system, in accordance with an embodiment of the present disclosure;

FIG. 6 is a cross-sectional view of two panels of a configurable steel form separation system, in accordance with an embodiment of the present disclosure;

FIG. 7A is a perspective view of a configurable form system that includes a form member configured to be coupled with a face or shoring apparatus, in accordance with an embodiment of the present disclosure;

FIG. 7B is a perspective view of a configurable form system that includes a form member and a removable face being coupled to the form member, in accordance with an embodiment of the present disclosure;

FIG. 7C is a perspective view of a configurable form system that includes a form member and a removable face coupled to the form member, in accordance with an embodiment of the present disclosure;

FIG. 7D is a perspective view of a configurable form system that includes a form member and a removable face coupled to the form member, in accordance with an embodiment of the present disclosure;

FIG. 8A is a perspective view of a configurable form system that includes a section and removable faces coupled to the section, in accordance with an embodiment of the present disclosure;

FIG. 8B is a perspective view of a configurable form system that includes a section and removable faces coupled to the section, in accordance with an embodiment of the present disclosure;

FIG. 9A is a perspective view of a configurable form system that includes a framework and a shoring apparatus coupled to the framework, in accordance with an embodiment of the present disclosure;

FIG. 9B is a perspective view of a shoring apparatus with a top and bottom chamfer, in accordance with an embodiment of the present disclosure;

FIG. 9C is a perspective view of a shoring apparatus with rounded and patterned top and bottom chamfers, as well as a front portion configured to emboss a panel, in accordance with an embodiment of the present disclosure; and

FIG. 10 is a perspective view of an extrusion mold that can be used to fabricate a shoring apparatus, in accordance with an embodiment of the present disclosure.

### DETAILED DESCRIPTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

FIG. 1 is a perspective view of a configurable steel form system, designated generally as 10, in accordance with an embodiment of the present invention. The configurable steel form system 10 can be used to create precast concrete panels, sized to a particular application. The configurable steel form system 10 can include three or more sections 12. The section 12 requires a Form A member 14. However, one or more Form B members 16 can be securably coupled to the Form A member 14 to elongate the section 12 to size the section 12 for a particular application. In such a configuration, the Form A member 14 and the one or more Form B members 16, comprise a section 12.

A J-channel member forms the primary framework for both the Form A member 14 and the Form B member 16. The J-channel member can be fabricated using a unitary ⅛ or 3/16-inch steel plate bent into a figure “J” to form a J-channel within the J-channel member. The J-channel member preferably includes a 6″ base, with a 6″ first side upwardly extending from one end of the base and a 1½″ second side upwardly extending from another end of the base. A 2″ top side is formed by the portion of the J-channel member that extends, at a right angle, toward the second side, from the first side. However, the J-channel member can be fabricated using any suitable material and comprise any suitable size. The top of the J-channel member can include graduated markings to indicate length taken one or both ends of the J-channel member. The J-channel member can include a gusset rib 18, an anchor hole 20, an anchor plate 34, a chamfer 42, and a connector plate 26. A plurality of 3/16″ steel plate gussets 18 can be disposed within the J-channel member at predetermined intervals (e.g., every 12″). The gussets 18 can be welded to the J-channel member, however, any suitable attachment process can be used. A plurality of ⅜″ slotted, anchor holes 20 can be disposed within the bottom of the J-channel member. The anchor holes 20 can be slotted, having a length greater than a width. Alternatively, an anchor hole plate, having anchor holes 20, can be disposed over openings in the base of the J-channel member.

A chamfer 42 can be disposed along a top edge of a first side of each of the J-channel members. In another embodiment, a chamfer 42 can be disposed on a face or shoring apparatus (like those discussed with respect to FIGS. 7A-7D, 8A-8B, 9A-9B, and 10) that can be coupled to each of the J-channel members or sections composed therefrom. The chamfer 42 is preferably fabricated using ¾″ steel or high-density polyethylene. The chamfer can be comprised of angle moldings that trace a profile slope of a concrete panel. The chamfer 42 can be triangular, rounded, or of a varying shape. The chamfer 42 can be welded, or otherwise secured, to the J-channel member. A chamfer 42 can also be disposed along a bottom edge of a first side of each of the J-channel members. The chamfers can outwardly extend from the J-channel members to mold the edges of a concrete panel. Alternatively, the chamfers 42 can be selectively excluded on one or more sides of the system 10. The chamfers 42 are preferably welded to the J-channel member to provide secure, stable attachment to the first side of the J-channel member. The chamfers 42 are preferably triangular with one side securably coupled to the first side of the J-channel member and a second side extend outwardly to ¾″ from the top of the J-channel member, and the hypotenuse tapering from the outermost point of the second side of the chamfer 42 to the bottommost point of the first side of the chamfer 42, which is attached to the J-channel member. The J-channel members can also include a connector plate 26 disposed on either side, or both of the J-channel member. The connector plate 26 is preferably fabricated using ⅜″ steel. The connector plate 26 is held in place by the “J”-shape of the J-channel. The J-channel member can include top and bottom tie-holes at certain intervals along the first side. The tie holes are preferably 1/18 inch holes disposed every six inches, but can be sized based upon the particular application. Plates can be used to stand the concrete panels or a welding plate for structural steel roof beams, such that a plurality of metal imbeds may exist in the concrete panel. A length of wire can secure the plates to a metal form. Accordingly, the plate can be positioned level with the steel form system 10 and the wire can be used to cross-tie the plate to maintain its position when the concrete is poured.

The Form A member 14 is preferably a system 10 receiver member formed using the J-channel member as a framework. The Form A member 14 has a mitered end on a first end of the Form A member 14 and alignment tubes disposed proximate the connector plate 26 on a second end of the Form A member 14. The Form A member 14 is preferably 10-feet, 6-inches (10′ 6″) long. The chamfer 42 of the Form A member 14 can have a 45-degree miter on one end, so to operably engage another Form A member 14 or Form B member 16 between top and bottom chamfers 42. The chamfers 42 preferably extend ¾″ from the J-channel member. Such a length allows the mitered end of a Form A member 14 to securely engage a section 12, without the need of fasteners, clips, or other retaining mechanisms. However, any suitable chamfer length is possible. The mitered edges of the Form A member 14 are angled at the same angle as the chamfers 42 of Form A member 14 or Form B member 16, to securely engage the Form A member 14 to another Form A member 14 or a Form B member 16. The connector plate 42 of the Form A member 14 can have an alignment tube 30 disposed proximate the connector plate to create a flush side and extend away from the flush side within the J-channel member.

The Form B member 16 is preferably a 10-foot (10′) long extension member. Connector plates 26 are disposed on both sides of the Form B member 16, to create a first and second end flush with the Form B member 16. The Form B member 16 can include alignment pins 28 outwardly extending from the connector plate 26 on a first end and an alignment tube 30 disposed proximate the connector plate and extending away from the flush side, within the Form B member 16. A Form B member 16 of any suitable material or sizing can be used.

The configurable steel form system 10 includes a plurality of sections 12 to form an enclosed area. As few as three sections 12 can be used to form a triangular concrete panel, but preferably, four sections 12 are incorporated to form rectangular concrete panels. However, additional sections 12 can be added to form pentagonal, hexagonal, heptagonal, octagonal, or any poly-sided concrete panel. Such configurations are made possible by at least the mitered-end of the Form A member 14, the stability of the chamfers 42, and the base of the J-channel member, all working together. Advantageously, by adding one or more Form B members 16 to a Form A member 14, the system 10 can be configured to form a concrete panel of any size.

In one exemplary application, four sections 12 are operatively engaged to form an enclosed area. Concrete can then be poured into the enclosed area to form a concrete panel. First, a protective layer must be placed on a casting bed to prevent the concrete from adhering to the casting bed surface. The protective layer can be a sheet, chemical (such as a bond-breaker liquid), or other suitable layer that can be disposed between the casting bed and the concrete.

A first section 12 can be disposed on a casting bed. The casting bed can be a concrete pad, or other suitable level surface. The first section 12 can be coupled to the concrete pad by drilling a hole into the pad, aligned with the anchor holes 20, and securing the section 12 to the pad with a bolt or other suitable device through the anchor holes 20. Due to the weight and durability of the section 12, adherence to the surface is not required, but can provide additional stability where needed. In, for example, industrial jobs, drilling may not be possible, accordingly, an adhesive, can be used to secure the section 12 to the pad, as needed. A second section 12 can be disposed perpendicular to the first section 12, such that the mitered end of the second section 12 engages the first section 12 to form a first corner. The second section 12 can be secured to the pad by drilling holes and inserting bolts through the anchor holes 20. A third section 12 is disposed perpendicular to the second section 12, such that the mitered end of the third section 12 engages the second section 12 to form a second corner. The second section 12 can be secured to the pad by drilling holes and inserting bolts through the anchor holes 20. A fourth section 12 is disposed perpendicular to the third section 12, such that the mitered end of the fourth section 12 engages the third section 12 to form a third corner. The fourth section 12 is also perpendicular to the first section 12, such that the mitered end of the first section 12 engages the fourth section 12 to form a fourth corner. The fourth section 12 can be secured to the pad by drilling holes and inserting bolts through the anchor holes 20.

The dimensions of the panel to be formed can be determined by the position of the corners as identified by the length from the mitered end of the section 12, such as with the graduated markings at the top of each J-channel member. If the desired panel length on a particular side of a section 12 exceeds the 10′ 6″ length of the section 12, consecutive Form B members 16 can be coupled to the section 12 to extend it to the desired length.

Referring to FIG. 2A, there is shown a perspective view of a first end of a Form B member 16, in accordance with an embodiment of the present invention. The connector plate 26 is disposed on the first end of the Form B member 16, such that the connector plate 26 is flush with the first end of the Form B member 16. The Form B member 16 can include alignment pins 28 outwardly extending from the connector plate 26 on a first end. The alignment pin 28 can be securely coupled within an alignment tube 30 that can be securely coupled to the connector plate 26. The alignment pin 28, alignment tube 30, and connector plate 26 are preferably welded together, but any suitable coupling can be used. By disposing the alignment pin 28 within an alignment tube 30, the alignment pin 28 is reinforced such that the likelihood off snapping off the alignment pin 28 off of the connector plate 26 is greatly reduced. The form B member 16 can include one or more connector holes 32 disposed within the connector plate 26. The Form B member 16, the connector plate 26, and the alignment pins 28 are preferably made of steel, but any suitable material or sizing can be used.

FIG. 2B is a perspective view of a second end of a Form A member 14, in accordance with an embodiment of the present invention. The connector plate 26 is disposed on the second end of the Form A member 14, such that the connector plate 26 is flush with the second end of the Form A member 14. The Form A member 14 can include alignment tubes 30 disposed proximate the connector plate and extending within the Form A member 14. The Form A member 14 can include one or more connector holes 32 disposed within the connector plate 26. The Form A member 14, the connector plate 26, and the alignment pins 28 are preferably made of steel, but any suitable material or sizing can be used. The alignment tube 30 can be securely coupled to the connector plate 26. The alignment tube 30 and connector plate 26 are preferably welded together, but any suitable coupling can be used.

FIG. 2C is a perspective view of a first end of a Form B member 16 aligned with a second end of a Form A member 14, for formation of a section, in accordance with an embodiment of the present invention. The Form A member 14 has alignment tubes 30 disposed proximate the connector plate 26 on a second end of the Form A member 14. The alignment pins 28 on the first end of the Form B member 16 are aligned with the alignment tubes 30 on the second end of the Form A member 14. The connector holes 32 of the second end of the Form A member 14 align with the connector holes 32 of the first end of the Form B member 16, such that a securing mechanism can be disposed therethrough to securely couple the connector plate 26 of the Form A member 14 with the connector plate of the Form B member 16. The securing mechanism is preferably a bolt and a nut, however, any suitable securing mechanism can be used. In this manner, additional Form B members 16 can be aligned, attached, and secured to second ends of the Form B member 16 shown in FIG. 2C to create a section of any length.

FIG. 3A is a perspective view of a first end of a Form B member aligned with a second end of a Form A member, for formation of a section, in accordance with another embodiment of the present invention. The Form A member 14 has alignment tubes 30 disposed proximate the connector plate 26 on a second end of the Form A member 14. The alignment pins 28 on the first end of the Form B member 16 are aligned with the alignment tubes 30 on the second end of the Form A member 14. The connector holes 32 of the second end of the Form A member 14 align with the connector holes 32 of the first end of the Form B member 16, such that a securing mechanism can be disposed therethrough to securely couple the connector plate 26 of the Form A member 14 with the connector plate of the Form B member 16.

The securing mechanism is preferably a bolt and a nut, however, any suitable securing mechanism can be used. A bolt 36 is shown disposed in a first connector hole 32 of the connector plate of the Form B member 16. The securing mechanism can also be a quick-connect system, including a quick-connect pin 38 and a quick-connect receiver 40. The quick-connect pin 38 is preferably coupled to the connector plate 26 by a wing-nut, however alternative coupling mechanisms, such as traditional nuts, welding, or other suitable coupling techniques can be utilized. The quick-connect pin 38 preferably includes a shaft and a tip. The tip can have a greater diameter than the shaft. The quick-connect receiver 40 preferably includes a lever to selectively engage and release the tip of the quick-connect pin 38, however, any suitable mechanism to selectively engage and release the tip of the quick-connect pin 38 can be implemented. Advantageously, the quick-connect system can further reduce section setup time. Although the present embodiment discloses a single nut and bolt and a single quick-connect system, any combination or single usage of one nut and bolt, two nuts and bolts, one quick-connect system, two quick-connect systems can be implemented.

In this manner, additional Form B members 16 can be aligned, attached, and secured to second ends of the Form B member 16 shown in FIG. 2C to create a section of any length.

FIG. 3B is a perspective view of a second end of a Form A member aligned with a first end of a Form B member, for formation of a section, in accordance with another embodiment of the present invention. As seen from a different perspective, the Form A member 14 has alignment tubes 30 disposed proximate the connector plate 26 on a second end of the Form A member 14. The alignment pins 28 on the first end of the Form B member 16 are aligned with the alignment tubes 30 on the second end of the Form A member 14. The connector holes 32 of the second end of the Form A member 14 align with the connector holes 32 of the first end of the Form B member 16, such that a securing mechanism can be disposed therethrough to securely couple the connector plate 26 of the Form A member 14 with the connector plate of the Form B member 16.

FIG. 3C is a perspective view a first end of a Form B member coupled with a second end of a Form A member, to form a section, in accordance with another embodiment of the present invention. When the Form A member 14 is coupled to the Form B member 16, the connector plates 26, the second end of the Form A member 14, and the first end of the Form B member 16 are flush so that a continuous section 12 is formed. By having two connector plates disposed next to each other at the coupling location reinforces the coupling such that the coupling is secure. The chamfers are also aligned such that, although a plurality of members may be connected to create a section 12 of a desired length, section 12 substantially appears to be a single member, as the member heights, chamfer lengths can be same.

FIG. 4 is a perspective view of a mitered first end of a Form A member 14, in accordance with an embodiment of the present invention. The first end of the Form A member 14, is preferably inwardly mitered at a 45 degree angle from the first end of the Form A member 14. The chamfer 42 is also preferably inwardly mitered at a 45 degree angle from the first end of the Form A member 14. Alternatively, the miter angles can be 30 degrees, 60 degrees, or any suitable angle. The miter of the first end of a Form A member 14 begins at the bottom edge of the chamfer 42. This is so the first end of a Form A member 14 can engage a first side of a section 12 and the first sides and chamfers of all utilized sections can form a concrete panel of specified dimensions having uniform edges circumscribing the top and bottom edges on the concrete panel.

FIG. 5 is a perspective view of a corner of the configurable steel form system, in accordance with an embodiment of the present invention. As discussed above, the first end of a Form A member 14 can engage a first side of a section 12. Since the mitered end of the Form A member 14 is mitered at the same angle as the angle that the hypotenuse of the chamfer 42 diverges from the first end of the J-channel member, the mitered end of the Form A member 14 can engage the first end of the section 12 to form a fit with chamfer-to-chamfer contact of both the top and bottom chamfers of each section 12. The wide base of the J-channel member provides a stable foundation for a first section 12 to engage a second section 12. The sections 12 can be secured in place by the use of a bolt or other suitable securing means into the casting bed through the anchor holes 20.

FIG. 6 is a cross-sectional view of two sections of a configurable steel form separation system, in accordance with an embodiment of the present invention. In large applications, multiple concrete panels may need to be formed simultaneously to supply a particular job. However, the casting bed area may be substantial enough to allow for large distances between the sections 12 of a plurality of configurable steel form systems 10. In such environments, the steel form systems 10 are placed as close together as possible. Typically, all of the steel form systems 10 that can fit on the casting bed are setup and then the concrete is poured. If the steel form systems 10 are placed too close together, a first steel form system 10 will not be able to be removed from its concrete panels as it will abut a second steel form system 10 proximate to it. Additionally, the base of a J-channel member can be sized to conserve space on a particular casting bed.

As such, the J-channel member can include a spacer tab 44. The spacer tab 44 can be made of metal, or any suitable material and outwardly extend from the second side of the J-channel member. The spacer tab 44 preferably includes a spacer opening disposed therein. The spacer tab 44 can be securably attached to the second side of the J-channel member at predetermined locations via weld, adhesive, screw, or other suitable attachment processes.

A spacer 46 can be a bar having a predetermined length with 90-degree bends on both ends of the spacer 46. The spacer 46 is preferably made of metal and 1½″ long, but can be made of any suitable material and sized to any length. A first end of the spacer 46 can be adapted to removably engage the spacer opening in the spacer tab 44 coupled to a section 12 of a first steel form system 10 and a second end of the spacer 46 can be adapted to removably engage the spacer opening in the spacer tab 44 coupled to a section 12 of a second steel form system 10.

FIGS. 7A-7D depict another embodiment of the present disclosure. FIG. 7A shows a configurable form system 48 including a form member 50. In some embodiments, the form member 50 can comprise a Form A or Form B member such as those discussed herein; in other embodiments, the form member 50 can include any member, constituent, or form member of concrete panel frameworks known in the art, such as wooden frameworks, aluminum frameworks, or the configurable steel form system described herein. In one embodiment, the form member 50 can comprise a shoring surface 52; in another embodiment, a form member 50 can be a section 50, or multiple form members 50 can be connected to form a section 50, and such section 50 can include a shoring surface 52. In one embodiment, the shoring surface 52 can be configured to be enclosure-facing, such that, for example, the shoring surface 52 faces a slurry poured into an enclosure formed by one or more form members 50. For example, the shoring surface 52 can form substantially a ninety-degree angle (or any other suitable angle) with the ground on which the form member 50 sits, such that a concrete panel formed within an enclosure of form members 50 can adopt sides having similar angles and shapes as that of the shoring surface 52. In another example, the shoring surface 52 can be configured to couple to a removable face (e.g., 56 in FIG. 7B) or shoring apparatus that is designed to contact a slurry poured into the form created by form members 50. In one embodiment, the shoring surface 52 can include a coupling mechanism 54, such as for coupling to a removable face. In one embodiment, the shoring surface 52 can include a first part 54 of a two-part coupling mechanism. For example, the form member 50 can include a female half of a mechanical snap as a first part of a two-part coupling mechanism; in another example, the form member 50 can include a magnet of a certain polarity. In another embodiment, the form member 50 can be configured to receive and couple to, for example, a face—for example, the shoring surface 52 can comprise a hole 54 that can facilitate coupling or removable coupling of, for example, a face, to the shoring surface 52.

FIG. 7B depicts another embodiment of the present disclosure, wherein the configurable form system further includes a face 56 that can be coupled to the form member 50. For example, a face 56 having a top chamfer 58 and bottom chamfer 60 can be coupled to the surface 52 of the form member 50, such as is depicted in FIGS. 7B and 7C. In one embodiment, the face 56 can have only a top chamfer 58 or only a bottom chamfer 60, or alternatively, no chamfer(s). The face 56 can be of any suitable shape or design to lend shape to a concrete panel being formed within an enclosure of form members 50. For example, a face 56 with a first chamfer 58 disposed along a first or top edge of the face 56 (e.g. a top chamfer 58) and second chamfer 60 disposed along a second or bottom edge of the face 56 (e.g. a bottom chamfer 60) can form concrete panels with edges beveled at the chamfers; in another example, the face 56 can include rounded chamfers, imprints, or any other artistic or utilitarian design, such as one that could be transferred to the concrete panel being formed against the face 56. In one embodiment, the face 56 can comprise a second part 62 of a two-part coupling mechanism that can correspond to, for example, the first part 54 of the two-part coupling mechanism on the form member 50. For example, the second part 62 of the two-part coupling mechanism can be a male half of a mechanical snap; in another example, the face 56 can comprise a magnet of a certain polarity (such as to correspond to a magnet on the form member 50, or to facilitate attachment of the face 56 to the surface 52 of a metal form member 50). In another embodiment, the face 56 can comprise a hole 62 or holes 62 that correspond to a hole 54 or holes 54 in the form member 50, such that a bolt 64 can be inserted through the holes 54, 62 and traverse the thicknesses of the face 56 and surface 52 of the form member 50 to receive, for example, a wing nut 66 on the opposing side of the surface 52. In this manner, the face 56 can be configured to be coupled to the form member 50 via tightening of the wing nut 66 on the bolt. In another embodiment, the face 56 can be configured to be coupled to the form member 50 via any suitable mechanism, including magnets, adhesive, welding, Velcro®, mechanical snaps, ties, straps, or any other mechanism suitable to attach the face 56 to the form member 50. In another embodiment, as shown in FIG. 7D, a configurable form system 68 can include a form member 70 different from form member 50 depicted in FIGS. 7A-7C, and a face 72 (or face 56) can be coupled to the form member 70.

FIGS. 8A-8B depict another embodiment of the present disclosure. A form member 76 can be a section 74 or can be coupled together with another form member, in accordance with the principles of the present disclosure, to form a section 74. Two faces 80, 82 can be coupled to the shoring surfaces of the section 74 via bolts 84. Preferably, the faces 80, 82 are each around five feet long (meaning that two faces placed end-to-end can extend about the length of, for example, a Form A or Form B member), and, in one embodiment, two faces 80, 82 can couple to one form member 76. In one embodiment, the bolts 84 can engage with nuts 78 on the back of the section 74. In one embodiment, the nuts 78 can be wing nuts, hex nuts, jam nuts, square nuts, or any other type of fastener suitable to engage, for example, the bolts 84 and secure the face 80 or faces 80, 82 to the section 74. In another embodiment, the faces 80, 82 can be made of high-density polyethylene, plexiglass, polytetrafluoroethylene, or any other material suitable to abut a material poured within an enclosure formed by sections 74. In another embodiment, the faces 80, 82 can be any material capable of being extruded via techniques known in the art, such as with the extrusion mold shown in FIG. 10.

FIG. 9A depicts another embodiment of the present disclosure. A configurable form system 86 can comprise a form member (section) (framework) 88 in accordance with the principles of the present disclosure, and the section 88 can include a top portion (top edge) 92. A shoring apparatus (face) 90 can be coupled to the section 88, and the apparatus 90 can also include a top portion 94. In one embodiment, the top portion 94 of the apparatus 90 can extend beyond the top portion 92 of the section 88; in another embodiment, the top portion 94 of the face 90 can be disposed below the top portion 92 of the member 88; in another embodiment, the top portion 92 of the face 90 can be of an equal height with the top portion 92 of the section 88. In this manner, the system 86 can, for example, enable the formation of concrete panels of varying thicknesses by changing out the shoring apparatus 94. For example, faces of variable heights can be used with the same sections 88, and such faces can be removably coupled to the sections 88 such that they can be interchanged. In one embodiment, the shoring apparatus 90 can be of standardized sizes to facilitate formation of concrete panes in conformance with industry standards. For example, the apparatus 90 can be of heights such as 5½ inches, 7¼ inches, 9¼ inches, and 11¼ inches, to enable formation of concrete panels of corresponding thicknesses. In another embodiment, faces of one size can be configured to couple to the same sections or form members as faces of a different size. In this manner, one section, collection of sections, or collection of form members can enable the formation of any size of concrete panel by interchanging faces or shoring apparatuses to achieve a desired panel thickness.

In one embodiment, and as depicted in FIG. 9B, the shoring apparatus 90 can comprise a top portion 94, a bottom portion 96, a front portion 102, and a back portion 104. The apparatus 90 can include a first chamfer (top chamfer) 98 disposed along the top portion 94 of the apparatus 90, and a second chamfer (bottom chamfer) 100 disposed along the bottom portion 96 of the apparatus. The apparatus 90 can have a predetermined height, notated as “X.” The apparatus 90 can facilitate the fabrication of panels of variable thickness by varying the height X—for example, the larger X is, the thicker the panel to be formed can be. In one embodiment, the back portion 104 of the apparatus 90 can be configured to abut a section, frame member, or framework, such as those known in the art and discussed herein. For example, the back portion 104 can be flat, corrugated, or of any other shape or texture suitable to allow the apparatus 90 to lay against a section, frame member, or framework while material is applied to the front portion 102. In another embodiment, the front portion 102 can be configured to contact material, such as material poured into an enclosure formed by a framework. For example, the front portion 102 can be a smooth and flat surface to facilitate the creation of smooth and flat sides of a panel; in another example, the front portion 102 can be textured or include raised designs operable to imprint on a panel being formed against the front portion 102. In another example, the front portion 102 can be overhung by a chamfer 98 or chamfers 98, 100, such that edges of the panel formed at the front portion 102 can be beveled.

In another embodiment, the apparatus 90 can include a coupling mechanism 106 to facilitate coupling (preferably, removable coupling) of the apparatus 90 to a section, form member, or framework such as those known in the art and/or described herein. The coupling mechanism 106 can be any mechanism suitable to couple the apparatus 90, and the mechanism 106 can vary as necessary to adapt to forms or frameworks of different designs. For example, the mechanism 106 can be a magnet to enable coupling of the apparatus 90 to, for example, a steel form member. In another example, the coupling mechanism can be an adhesive, such that the apparatus 90 can stick to a form, such as an aluminum form (in this embodiment, adhesive can be applied to the back portion 104 to allow adherence of the back portion 104 to a section). As another example, the mechanism 106 can include a set screw integral with the apparatus 90, such that when the apparatus 90 is in a preferred placement relative to the section, the screw can be engaged and driven into the form, effectively securing or coupling the apparatus 90 to the form. As another example, the coupling mechanism 106 can be a ratchet mechanism with a head that secures the mechanism to the apparatus 90, and a strap or tie and ratchet that extend from the head and through the form member to facilitate tightening of the apparatus 90 against the form. Preferably, the apparatus 90 can include holes 106 with an interior rim, such that the holes 106 can be configured to receive a fastener (such as bolts, screws, etc.) and allow part of the fastener (e.g. the threads) to extend through the apparatus while preventing the head of the fastener to travel therethrough. In this manner, a bolt can extend through the apparatus 90 and into a section. For example, a bolt can be a wood bolt or screw such that the apparatus 90 can be secured directly to a wood framework without prefabricated holes. In another example, the coupling mechanism 106 can be holes 106 that can correspond to counterpart holes in a form member or section, such that a bolt can extend through the holes 106 of the apparatus and holes of the form (such as those depicted at 54 in FIG. 7A) to receiver, for example, a nut on the threads of the bolt (e.g., as can be seen in FIGS. 8A-8B). Tightening of the nut can facilitate securing of the apparatus 90 to a section.

FIG. 9C depicts another embodiment of the present disclosure. A shoring apparatus 108, which can be similar to shoring apparatus 90, can comprise a top portion 110, a bottom portion 112, a top chamfer 114, a bottom chamfer 116, a front portion (embossing portion) (imprinting portion) 118, a back portion 120, a coupling mechanism 122, and a height X. Like with respect to shoring apparatus 90, the height X of shoring apparatus 108 can be variable, such that the apparatus 108 can facilitate the formation of panels of variable thickness. In one embodiment, the chamfers 114, 116 can be rounded as seen in FIG. 9C, such that “edges” of a panel formed at the chamfers can also be rounded. In another embodiment, and as depicted in FIG. 9C, the chamfers 114, 116 can be ruffled, jagged, wavy, or display any other design desired to be embossed or imprinted on a panel being formed against the apparatus 108. The chamfers 114, 116 can be of any shape or design suitable to provide structure to a forming panel and/or imprint or emboss any desired design, shape, logo, or appearance to a forming panel. In another embodiment, the front portion 118 can include an embossing surface 118 and can include any embossing mechanism to transfer to a design to a forming panel; for example, the embossing surface 118 can include a recessed star design, such that the star design is embossed onto a panel. In another embodiment, the front portion 118 can include an imprinting surface 118 that can include a raised design, such a design can be imprinted onto a forming panel. For example, the front portion 118 can include a raised or recessed logo, pattern, or other design to be transferred to a panel forming against the apparatus 108. Similar to apparatus 90, shoring apparatus 108 can include a back portion 120 operable to coupled to a section or form member. The back portion 120 can be flat, corrugated, or have any desired shape or design that allows the apparatus 108 to be coupled to a section. In another embodiment, the apparatus 108 can include a coupling mechanism 122. For example, the apparatus 108 can include holes 122 configured to receive bolts or screws, such as to secure the apparatus 108 to a section. The coupling mechanism 122 can be any suitable attachment mechanism known in the art to secure or removably secure the apparatus 108 to a section, form member, or framework.

The chamfers discussed herein with respect to the faces and shoring apparatus can be configured to participate in the engagement of an end of a section with the chamfered side (chamfered face, e.g., 56 in FIGS. 7A-7D) of another section, in accordance with principles of the present disclosure. The systems and methods disclosed herein can also be utilized in any order or combination to accomplish the fabrication or formation of, for example, panels, such as masonry panels, concrete panels, or any other panels that are suitable to be fashioned from, for example, slurries or liquids. For example, the form members (e.g., 50, 70, Form A, Form B, etc.) can be connected in series to create sections (or can themselves be sections), such as those seen in FIG. 1; alternatively, sections utilizing other types of frameworks known in the art (e.g. wood, aluminum, etc.) can be used. The sections can form an enclosure (again as seen in FIG. 1) into which a material can be deposited. In one embodiment, a shoring apparatus (face) disclosed herein (e.g., 56, 72, 80, 82, etc.) can be a stand-alone construct separate and apart from the section or forms to which they are attached, a novel and extremely advantageous feature. The shoring apparatus can be coupled or removably coupled to the sections such that an inner circumference of the enclosure is formed by series of faces. The faces, interchangeable with faces having different heights, designs, or other characteristics, can then facilitate the containment and shaping the material within the enclosure.

The present invention achieves at least the following advantages:
1. an apparatus that enables fabrications of panels of variable width from a framework of a single height;
2. removable faces in a configurable form system that reduce the weight of a given section or form member (i.e. no permanently-attached chamfer, which are generally made of steel, that adds significant weight), increasing usability;
3. ability to fabricate panels of variable thickness by easily exchanging faces of one height for faces of a different height;
4. decreased cost of fabricating a given section or form member, as faces with any desired quality can be extruded and attached to the section or form member;
5. significant cost savings by eliminating waste associated with the fabrication process;
6. balance of durability and ease of use;
7. given a concrete panel crew with a heavy workload, conservatively, approximately seven workers are required over the course of twelve days with the present invention, versus twelve workers over fifteen days for wooden framework setup;
8. creates a fitted corner;
9. can be used for stackable cement pours;
10. modular and configurable;
11. single frame embodiment;
12. reusability;
13. dimensional adaptability;
14. securable to casting surface with adhesive in lieu of anchors.

While the invention has been shown in one of its forms, it is not thus limited and is susceptible to various changes and modifications without departing from the spirit thereof. Persons skilled in the art will understand that this concept is susceptible to various changes and modifications, and may be implemented or adapted readily to other types of environments. Further, the individual elements of the claims are not well-understood, routine, or conventional. Instead, the claims are directed to the unconventional inventive concept described in the specification.

What is claimed is:

1. A configurable form system, the system comprising:
a plurality of sections, each section having a shoring surface; and
a plurality of faces, each face configured to couple to at least one of the shoring surfaces;
wherein each of the shoring surfaces is configured to couple to at least one of the faces;
wherein each of the faces comprises a first chamfer disposed along a first edge of the face.

2. The system of claim 1, wherein the sections are formed using one or more form members.

3. The system of claim 2, wherein each of the form members comprises a shoring surface configured to couple to at least one of the plurality of faces.

4. The system of claim 1, wherein each of the sections comprises a first hole corresponding to a second hole of one of the plurality of faces, wherein the first and second holes are configured to receive a fastener.

5. The system of claim 1, wherein each of the faces comprises a second chamfer disposed along a second edge of the face.

6. The system of claim 2, wherein each form member comprises a unitary J-channel.

7. The system of claim 2, wherein the form members are made of steel.

8. The system of claim 1, wherein each of the plurality of faces is made of high-density polyethylene.

9. The system of claim 1, wherein a top edge of each of the faces extends beyond a top edge of the section the face is coupled to.

10. The system of claim 1, wherein a top edge of each of the faces is disposed below a top edge of the section the face is coupled to.

11. The system of claim 1, wherein each section comprises a mitered first end, and wherein a first face coupled to a first section is adapted to removably engage the mitered end of a second section.

12. A method of forming panels, the method comprising the steps of:
providing a plurality of form members;
coupling a plurality of faces to the plurality of form members;
coupling the plurality of form members to one another to form at least three sections;
removably engaging the three sections with one another to form an enclosure; and
depositing a material within the enclosure,
wherein the plurality of faces form an inner circumference of the enclosure.

13. The method of claim 12, wherein each of the faces comprises at least one chamfer disposed on an edge of the face.

14. The method of claim 12, wherein each of the faces comprises a top chamfer and a bottom chamfer.

15. The method of claim 12, wherein each section comprises a mitered first end, and wherein a first face coupled to a first section is adapted to removably engage the mitered end of a second section.

16. A shoring apparatus comprising:
a back portion configured to abut a first section;
a front portion configured to contact a material;
a top portion comprising a first chamfer;
a bottom portion comprising a second chamfer; and
a coupling mechanism configured to removably couple the apparatus to the first section.

17. The shoring apparatus of claim 16, wherein the coupling mechanism comprises at least one hole configured to receive a fastener.

18. The shoring apparatus of claim 17, wherein the coupling mechanism further comprises a threaded fastener and nut configured to secure the shoring apparatus to the section.

19. The shoring apparatus of claim 16, wherein the shoring apparatus is made of high-density polyethylene.

20. The shoring apparatus of claim 16, wherein the front portion of the shoring apparatus is configured to removably engage an end of a second section.
